(19) United States
(12) Patent Application Publication
(10) Pub. No.: US 2022/0374561 A1
(43) Pub. Date: Nov. 24, 2022

(54) DRILL BIT DESIGN METHOD BASED ON ROCK CRUSHING PRINCIPLE WITH LOCAL VARIABLE STRENGTH

(71) Applicant: SOUTHWEST PETROLEUM UNIVERSITY, CHENGDU CITY (CN)

(72) Inventors: Guangjian Dong, CHENGDU CITY (CN); Yingjie Chen, CHENGDU CITY (CN); Jianhong Fu, CHENGDU CITY (CN); Kanhua Su, CHENGDU CITY (CN); Qiang Han, CHENGDU CITY (CN)

(73) Assignee: SOUTHWEST PETROLEUM UNIVERSITY, CHENGDU CITY (CN)

(21) Appl. No.: 17/871,897

(22) Filed: Jul. 23, 2022

(30) Foreign Application Priority Data
Nov. 25, 2021 (CN) 202111409173.5

(51) Int. Cl. G06F 30/17; E21B 10/43; E21B 10/14; E21B 10/567; E21B 49/00

(52) U.S. Cl. CPC G06F 30/17; E21B 10/43; E21B 10/14; E21B 10/567; E21B 49/003; G06F 2119/14

(57) ABSTRACT

The invention discloses a drill bit design method based on rock crushing principle with local variable strength, including: drill bit is divided into local crushing feature regions; strength mode factors of the local crushing feature regions are calculated; a difference among strength mode factors of the local crushing feature regions is obtained to obtain a vector sum of horizontal cutting forces of the drill bit tooth corresponding to the same group of cutting tooth on the drill bit; treating the difference among the strength mode factors of the local crushing feature region as a target control condition for drill bit design. Based on the rock crushing principle with local variable strength, after dividing the symmetrical cutting tooth into groups, the strength variation factors of the symmetrical position are adjusted and balanced, so that the rock crushing strength of different local crushing feature regions can be changed in a targeted manner.

### FIELD OF THE INVENTION

The present invention relates to the technical field of drill bit design method, in particular to a drill bit design method based on rock crushing principle with local variable strength.

### BACKGROUND OF THE INVENTION

With the deepening of exploration and development of oil and gas fields, the focus of oil and gas development has gradually shifted to oil and gas resources in deep strata. As a result, the strata to be drilled become more and more complex, the drilling difficulty becomes more and more difficult, and the wellbore trajectory becomes more and more complex, including deep wells, ultra-deep wells and complex structural wells. The burial conditions of deep oil and gas resources are complex (including high temperature, high pressure, high sulfur content and low permeability, etc.), with characteristics of deep burial, compact rock and great lithology change of stratum, as well as high strength, high hardness, poor drill ability, strong abrasiveness, and strong heterogeneity of the rocks encountered. When a conventional drill bit in such strata, the life of a single bit is short, the footage is small, the average rate of penetration (ROP) is very low, the cycle is long, and the cost is high.

In summary, whether the vibration is actively applied or passively generated, the dynamic strength of the complex rock at the bottom of the well cannot be simply ignored in the process of dynamically crushing rocks. In the actual drilling process, due to the movement of the drill string, the drill string inevitably collides with the wellbore wall, and the dynamic contact between the drill bit and the bottom hole crushes the rock, which makes the vibration environment under the well more complicated. The coupling effects of various factors, such as collision, rotation, dynamic rock crushing, and active application of dynamic loads, makes the measurement of vibration under the well and the study of interference in dynamically crushing rocks more complicated. The people's understanding of the vibration occurring in the process of dynamically crushing rocks in the well over the years has been summarized. According to the vibration direction, the downhole vibration performance can be divided into three basic forms, including axial (longitudinal), lateral, torsional vibrations. The specific manifestations include stick-slip vibration, bit bounce, bit vortex, BHA vortex, lateral impact, torsional resonance, parametric resonance, drill bit restlessness, vortex-induced oscillation, and coupled vibration. Among them, stick-slip vibration, vortex, bounce and impact cause relatively large damages, and are the key research objects. The actual rock crushing is completed under the action of complex dynamic loads. The causes of complex vibration environment in well can be divided into two aspects: one is the auxiliary vibration rock breaking caused by actively applying engineering measures, and the other is the inevitable passive occurrence of the movements from the drill string or drill bit. There are two reasons for dynamic loads: \textcircled{1} actively applying engineering measures (active excitation dynamic load, rotational speed dynamic load, axial impactor, torsional impactor, roller-cone bit, compact bit, screw motor, turbine motor, rotary steering system, PDC/drag bit) causes regular dynamic loads, wherein the maximum frequency exceeds 45 Hz, the maximum amplitude exceeds 30 g, and the maximum dynamic load strain rate of comprehensive performance exceeds 100 s⁻¹; \textcircled{2} the contact between the drill bit and the strata passively generates axial, lateral and torsional random dynamic loads, wherein the maximum frequency exceeds 350 Hz, the maximum amplitude exceeds 100 g, and the comprehensive maximum dynamic load strain rate exceeds 150⁻¹. In the process of pyrolysis drilling, rocks are subjected to alternating thermal loads with large temperature differences, and the maximum temperature exceeds 600° C. In summary, whether the vibration is actively applied or passively generated, the dynamic strength of the complex rock at the bottom of the well cannot be simply ignored in the process of dynamically crushing rocks.

For the conventional drill bit design method, for example, the patent CN201010500274.9 disclosed a fractal design method for diamond particle distribution on diamond bit, which provides a design method for the size, quantity and distribution of diamond particles of a diamond drill bit. The patent CN201010500309.9 disclosed a fractal design method for roller bit teeth structure, which provides a design method for the size, quantity and distribution of a roller bit teeth. The conventional drill bit design method only starts from a single factor such as drilling parameters, diamond particles and roller-cone teeth to study the drill bit design method, but ignores the influence of changes in the dynamic strength properties of complex rocks at the bottom of the hole on the working state of the drill bit in the process of dynamically crushing rocks. Therefore, the performance of the designed drill bit is limited.

Early drill bit designs often used a “trial-and-error” method, which only considers the influence of weight-on-bit on the static strength of the drill bit, i.e., a single factor, and does not consider the influence of dynamic changes in rock strength. Therefore, the performance and the ROP of the designed drill bit are limited. The drill bit completes drilling by crushing rocks in the bottom hole with drill bit tooth, so the ROP and life of the drill bit are directly related to the performance of the rocks in the bottom hole. When the traditional drill bit encounters the strata, the strength of each symmetrical group of main cutting tooth on the drill bit is different, which cannot be effectively adjusted according to different local crushing feature regions, so that each symmetrical group of the main cutting tooth on the drill bit have different degrees of wear, the drill bit is easily damaged, and the rock crushing efficiency is low.

Therefore, it is considered that an optimized drill bit design method is established based on rock crushing principle with local variable strength. Here, the strength experienced by each symmetrical group of main cutting tooth on the drill bit is fully considered; (1) the drill bit is divided into local crushing feature regions as a whole; (2) strength mode factors of the local crushing feature regions are calculated; (3) a different among the strength mode factors of the local crushing feature regions is obtained to obtain a vector sum of horizontal cutting forces of the drill bit tooth corresponding to the same group of cutting tooth on the drill bit; (4) treating the difference among the strength mode factors of the local crushing feature region as a target control condition for drill bit design. In this method, based on the rock crushing principle with local variable strength, after dividing the symmetrical cutting tooth into groups, the strength variation factors of the symmetrical position are adjusted and balanced, and the strength of different symmetrical positions on the drill bit can be adjusted to be different, so that the rock crushing strength of different local crushing feature regions can be changed in a targeted manner, and the failure of the drill bit caused by the inability to control the strength of each main cutting tooth of the traditional drill bit by region is eliminated, thereby improving the rock crushing efficiency of the drill bit, prolonging the service time and having broad application prospects.

### SUMMARY OF THE INVENTION

The objectives of the present invention is to overcome the shortcomings of the prior arts, and to provide a drill bit design method based on rock crushing principle with local variable strength. The method includes steps of: first, the drill bit is divided into local crushing feature regions as a whole; then, strength mode factors of the local crushing feature regions are calculated; and then, a different among the strength mode factors of the local crushing feature regions is obtained to obtain a vector sum of horizontal cutting forces of the drill bit tooth corresponding to the same group of cutting tooth on the drill bit; finally, treating the difference among the strength mode factors of the local crushing feature region as a target control condition for drill bit design. In this method, based on the rock crushing principle with local variable strength, after dividing the symmetrical cutting tooth into groups, the strength variation factors of the symmetrical position are adjusted and balanced, and the strength of different symmetrical positions on the drill bit can be adjusted to be different, so that the rock crushing strength of different local crushing feature regions can be changed in a targeted manner, and the failure of the drill bit caused by the inability to control the strength of each main cutting tooth of the traditional drill bit by region is eliminated, thereby improving the rock crushing efficiency of the drill bit, prolonging the service time and having broad application prospects.

In order to achieve the above-mentioned objectives of the invention, the following technical scheme are adopted.

A drill bit design method based on rock crushing principle with local variable strength includes the following steps:

Step S1: selecting a type of a drill bit, a number of blades and a type of a drill bit tooth, and using a processor for dividing the drill bit into a local crushing feature region as a whole according to a drill bit local crushing feature region division method, wherein the local crushing feature region includes a single crushing region and a mixed crushing region;

Step S2: using the processor for establishing a relationship among a dynamic rock uniaxial compressive strength, a static rock uniaxial compressive strength and a dynamic loading strain rate of a load; establishing a relationship among a dynamic rock tensile strength, a static rock tensile strength and the dynamic loading strain rate of the load; using the processor for establishing a relationship among a dynamic rock shear strength, a static rock shear strength and the dynamic loading strain rate of the load;

Step S3: using the processor for determining tooth distribution parameters preliminarily according to drill bit tooth overall mechanics balance conditions, and calculating bottom hole rock strength variation factors of the local crushing feature region and strength mode factors of the local crushing feature region according to the tooth distribution parameters of the drill bit and the relationship among the dynamic rock uniaxial compressive strength, the static rock uniaxial compressive strength and a dynamic loading strain rate of the load, the relationship among the dynamic rock tensile strength, the static rock tensile strength and the dynamic loading strain rate of the load and the relationship among the dynamic rock shear strength, the static rock shear strength and the dynamic loading strain rate of the load established in the Step S2;

Step S4: using the processor for controlling a difference among the strength mode factors of the single crushing region within 20% and controlling a difference among the strength mode factors of the mixed crushing region within 25% by adjusting drill bit parameters and regulating a difference among the strength mode factors of the local crushing feature region in the Step S3;

Step S5: using the processor for treating the difference among the strength mode factors of the local crushing feature region obtained in the Step S4 as a target control condition for drill bit design, wherein the drill bit design is completed if the target control condition for drill bit design is met, and the drill bit tooth distribution parameters are continued to be adjusted to meet the target control condition for drill bit design to complete the drill bit design if the target control condition for drill bit design is not met.

Further, in the Step S1, the type of the drill bit includes a PDC drill bit and a PDC-roller-cone compact drill bit; the number of blades includes a PDC drill bit with 4 blades, a PDC drill bit with 5 blades, a PDC drill bit with 6 blades, a PDC-roller-cone compact drill bit with 4 blades and a PDC-roller-cone compact drill bit with 6 blades, wherein the PDC-roller-cone compact drill bit with 4 blades is a roller-cone with 2 blades plus PDC with 2 blades, and the PDC-roller-cone compact drill bit with 6 blades includes a roller-cone with 2 blades plus PDC with 4 blades and a roller-cone with 3 blades plus PDC with 3 blades; the type of the drill bit tooth includes a plane cutting tooth and a tapered cutting tooth.

Further, in the Step S1, the drill bit tooth local crushing feature region division method specifically includes: using the processor for classifying symmetrical blades of the PDC drill bit with an even number of blades into one group, and dividing the drill bit tooth of the same type in each group of blades into the local crushing feature region; dividing the drill bit tooth of the same type of the PDC drill bit with an odd number of blades into the local crushing feature region; using the processor for classifying PDC blades of the PDC-roller-cone compact drill bit into the same group, dividing the roller-cone blades into the same group, and dividing the drill bit tooth of the same type in each group into the local crushing feature region.

Further, in the Step S1, the single crushing region includes a compressive crushing region, a shear crushing region and a tensile crushing region; the mixed crushing region is divided into a compressive-shear crushing region, a shear-tensile crushing region and a compressive-tensile crushing region.

Further, in the Step S2, the method of using the processor for establishing the relationship among the dynamic rock uniaxial compressive strength, the static rock uniaxial compressive strength and the dynamic loading strain rate of the load specifically includes: using the processor for measuring the dynamic rock uniaxial compressive strength by a split Hopkinson pressure bar (SHPB) rock mechanics experiment machine, and performing a curve fit on a ratio between the dynamic rock uniaxial compressive strength and the static rock uniaxial compressive strength and the dynamic loading strain rate of the load, so as to finally establish the relationship among the dynamic rock uniaxial compressive strength, the static rock uniaxial compressive strength and the dynamic loading strain rate of the load, which is specifically expressed as follows:

$$\frac{{σ}_{u c d}}{{σ}_{u c}} = \{ \begin{matrix}{a}_{1} {\dot{ε}}^{1 / ( 1 + {n}_{c} )} ( \dot{ε} < {\dot{ε}}^{*} ) \\ {a}_{2} {\dot{ε}}^{1 / n} ( \dot{ε} \geq {\dot{ε}}^{*} )\end{matrix}$$

in the Step S2, the method of using the processor for establishing the relationship among the dynamic rock tensile strength, the static rock tensile strength and the dynamic loading strain rate of the load specifically includes: measuring the dynamic rock tensile strength by the SHPB rock mechanics experiment machine, and performing a curve fit on a ratio between the dynamic rock tensile strength and the static rock tensile strength and the dynamic loading strain rate of the load, so as to finally establish a relationship among the dynamic rock tensile strength, the static rock tensile strength and the dynamic loading strain rate of the load, which is specifically expressed as follows:

$$\frac{{σ}_{t d}}{{σ}_{t}} = \{ \begin{matrix}{b}_{1} {\dot{ε}}^{1 / ( 1 + {n}_{c} )} ( \dot{ε} < {\dot{ε}}^{*} ) \\ {b}_{2} {\dot{ε}}^{1 / n} ( \dot{ε} \geq {\dot{ε}}^{*} )\end{matrix}$$

in the Step S2, the method of using the processor for establishing the relationship among the dynamic rock shear strength, the static rock shear strength and the dynamic loading strain rate of the load specifically includes: measuring the dynamic rock shear strength by the SHPB rock mechanics experiment machine, and performing a curve fit on a ratio between the dynamic rock shear strength and the static rock shear strength and the dynamic loading strain rate of the load, so as to finally establish a relationship among the dynamic rock shear strength, the static rock shear strength and the dynamic loading strain rate of the load, which is specifically expressed as follows:

$$\frac{{σ}_{s d}}{{σ}_{s}} = \{ \begin{matrix}{c}_{1} {\dot{ε}}^{1 / ( 1 + {n}_{c} )} ( \dot{ε} < {\dot{ε}}^{*} ) \\ {c}_{2} {\dot{ε}}^{1 / n} ( \dot{ε} \geq {\dot{ε}}^{*} )\end{matrix}$$

wherein a₁, a₂, b₁, b₂, c₁, c₂, n, n_{c} are fit coefficients, dimensionless; σ_{uc} is the static rock uniaxial compressive strength, MPa; σₜ is the static rock tensile strength, MPa; σₛ is the static rock shear strength, MPa; σ_{ucd} is the dynamic rock uniaxial compressive strength, MPa; σ_{td} is the dynamic rock tensile strength, MPa; σ_{sd} is the dynamic rock shear strength, MPa; \dot{ε} is the dynamic loading strain rate of the load, s⁻¹; \dot{ε}* is the dynamic loading critical strain rate of the load, s⁻¹.

Further, a calculation method of the dynamic loading strain rate of the load \dot{ε} in the process of crushing rocks with the drill bit tooth is expressed as follows:

$$\dot{ε} = \frac{1.4 {v}_{c} sin γ}{d sin ( γ + ω )}$$

wherein \dot{ε} is the dynamic loading strain rate of the load, s⁻¹; v_{c} is the cutting tooth speed, mm/s; d is the cutting depth, mm; γ is the drill bit tooth caster angle, rad; ω is the scrap forming-compaction transition angle, rad;

the cutting speed v_{ci} of the ith main cutting tooth on the drill bit is expressed as follows:

$${v}_{c i} = \frac{π {r}_{i} R P {M}_{n}}{30}$$

wherein rᵢ is a distance from a position where the ith main cutting tooth on the drill bit is located to an axis of the drill bit, m; RPMₙ is the rotating speed of the cutting tooth on the drill bit, r/min; v_{ci} is the cutting speed of the ith cutting tooth on the drill bit, m/s.

Further, in the Step S3, the tooth distribution parameters include the number of drill bit tooth, a diameter of each of the drill bit tooth, a caster angle of each of the drill bit tooth, and a distance from a position where each of the main cutting tooth is located to the axis of the drill bit.

Further, in the Step S3, the method of calculating bottom hole rock strength variation factors of the local crushing feature region specifically includes: using the processor for obtaining a relationship between the bottom hole rock strength variation factors and the drill bit tooth distribution parameters corresponding to each of the main cutting tooth by the curve fit method according to the relationship among the dynamic rock uniaxial compressive strength, the static rock uniaxial compressive strength and the dynamic loading strain rate of the load, the relationship among the dynamic rock tensile strength, the static rock tensile strength and the dynamic loading strain rate of the load and the relationship among the dynamic rock shear strength, the static rock shear strength and the dynamic loading strain rate of the load obtained in the Step S2, which is specifically expressed as follows:

$$\frac{{σ}_{ucdi}}{{σ}_{u c}} = \{ \begin{matrix}{a}_{1 i} {v}_{c i} \cdot {\frac{1.4 sin γ}{d sin ( γ + ω )}}^{1 / ( 1 + {n}_{c i} )} ( \dot{ε} < {\dot{ε}}^{*} ) \\ {a}_{2 i} {v}_{c i} \cdot {\frac{1.4 sin γ}{d sin ( γ + ω )}}^{1 / {n}_{i}} ( \dot{ε} \geq {\dot{ε}}^{*} )\end{matrix}$$

$$\frac{{σ}_{sdi}}{{σ}_{s}} = \{ \begin{matrix}{b}_{1 i} {v}_{c i} \cdot {\frac{1.4 sin γ}{d sin ( γ + ω )}}^{1 / ( 1 + {n}_{c i} )} ( \dot{ε} < {\dot{ε}}^{*} ) \\ {b}_{2 i} {v}_{c i} \cdot {\frac{1.4 sin γ}{d sin ( γ + ω )}}^{1 / {n}_{i}} ( \dot{ε} \geq {\dot{ε}}^{*} )\end{matrix}$$

$$\frac{{σ}_{tdi}}{{σ}_{t}} = \{ \begin{matrix}{c}_{1 i} {v}_{c i} \cdot {\frac{1.4 sin γ}{d sin ( γ + ω )}}^{1 / ( 1 + {n}_{c i} )} ( \dot{ε} < {\dot{ε}}^{*} ) \\ {c}_{2 i} {v}_{c i} \cdot {\frac{1.4 sin γ}{d sin ( γ + ω )}}^{1 / {n}_{i}} ( \dot{ε} \geq {\dot{ε}}^{*} )\end{matrix}$$

wherein a₁ᵢ, a₂ᵢ, b₁ᵢ, b₂ᵢ, c₁ᵢ, c₂ᵢ, nᵢ, n_{ci} are fit coefficients of the strength variation factor expression corresponding to the ith cutting tooth on the drill bit, dimensionless; σ_{ucdi} is the dynamic uniaxial compressive strength in the process of dynamically crushing rocks of the ith cutting tooth on the drill bit, MPa;

$$\frac{{σ}_{ucdi}}{{σ}_{u c}}$$

is the ratio between the dynamic uniaxial compressive strength and the static uniaxial compressive strength in the process of dynamically crushing rocks of the i th cutting tooth on the drill bit, compressive strength variation factors for short, dimensionless; σ_{sdi} is the dynamic shear strength in the process of dynamically crushing rocks of the ith cutting tooth on the drill bit, MPa;

$$\frac{{σ}_{s d i}}{{σ}_{s}}$$

is the ratio between the dynamic shear strength and the static shear strength in the process of dynamically crushing rocks of the ith cutting tooth on the drill bit, shear strength variation factors for short, dimensionless; σ_{tdi} is the dynamic tensile strength in the process of dynamically crushing rocks of the ith cutting tooth on the drill bit, MPa;

$$\frac{{σ}_{tdi}}{{σ}_{t}}$$

is the ratio between the dynamic tensile strength and the static tensile strength in the process of dynamically crushing rocks of the ith cutting tooth on the drill bit, tensile strength variation factors for short, dimensionless; σ_{uc} is the static rock uniaxial compressive strength, MPa; σₜ is the static rock tensile strength, MPa; σₛ is the static rock shear strength, MPa; v_{ci} is the cutting speed of the ith cutting tooth on the drill bit, m/s; d is the cutting depth, mm; γ is the caster angle of the drill bit tooth, rad; ω is the scrap forming-compaction transition angle, rad; \dot{ε}* is the dynamic loading critical strain rate of the load, s⁻¹.

Further, in the Step S3, the method of calculating the strength mode factors of the local crushing feature region includes:

when the local crushing feature region is the compressive crushing region:

$$LSC = Max \{ \frac{{σ}_{ucd 1}}{{σ}_{u c}} , \frac{{σ}_{u c d 2}}{{σ}_{u c}} , \frac{{σ}_{u c d 3}}{{σ}_{u c}} … \frac{{σ}_{u c d k}}{{σ}_{u c}} \} - Min \{ \frac{{σ}_{u c d 1}}{{σ}_{u c}} , \frac{{σ}_{u c d 2}}{{σ}_{u c}} , \frac{{σ}_{u c d 3}}{{σ}_{u c}} … \frac{{σ}_{u c d k}}{{σ}_{u c}} \}$$

when the local crushing feature region is the shear crushing region:

$$LSS = Max \{ \frac{{σ}_{s d 1}}{{σ}_{s}} , \frac{{σ}_{s d 2}}{{σ}_{s}} , \frac{{σ}_{s d 3}}{{σ}_{s}} … \frac{{σ}_{s d 1}}{{σ}_{s}} \} - Min \{ \frac{{σ}_{s d 1}}{{σ}_{s}} , \frac{{σ}_{s d 2}}{{σ}_{s}} , \frac{{σ}_{s d 3}}{{σ}_{s}} … \frac{{σ}_{s d 1}}{{σ}_{s}} \}$$

when the local crushing feature region is the tensile crushing region:

$$LST = Max \{ \frac{{σ}_{td 1}}{{σ}_{t}} , \frac{{σ}_{td 2}}{{σ}_{t}} , \frac{{σ}_{td 3}}{{σ}_{t}} … \frac{{σ}_{tdn}}{{σ}_{t}} \} - Min \{ \frac{{σ}_{td 1}}{{σ}_{t}} , \frac{{σ}_{td 2}}{{σ}_{t}} , \frac{{σ}_{td 3}}{{σ}_{t}} … \frac{{σ}_{tdn}}{{σ}_{t}} \}$$

when the local crushing feature region is the compressive-shear crushing region:

$$LSCS = Max \{ \frac{{σ}_{u c d 1}}{{σ}_{u c}} - \frac{{σ}_{s d 1}}{{σ}_{s}} , \frac{{σ}_{u c d 2}}{{σ}_{u c}} - \frac{{σ}_{s d 2}}{{σ}_{s}} , \frac{{σ}_{u c d 3}}{{σ}_{u c}} - \frac{{σ}_{s d 3}}{{σ}_{s}} , … \frac{{σ}_{u c d k}}{{σ}_{u c}} - \frac{{σ}_{s d m}}{{σ}_{s}} \} - Min \{ \frac{{σ}_{u c d 1}}{{σ}_{u c}} - \frac{{σ}_{s d 1}}{{σ}_{s}} , \frac{{σ}_{u c d 2}}{{σ}_{u c}} - \frac{{σ}_{s d 2}}{{σ}_{s}} , \frac{{σ}_{u c d 3}}{{σ}_{u c}} - \frac{{σ}_{s d 3}}{{σ}_{s}} , … \frac{{σ}_{u c d k}}{{σ}_{u c}} - \frac{{σ}_{s d m}}{{σ}_{s}} \}$$

when the local crushing feature region is the shear-tensile crushing region:

$$LSST = Max \{ \frac{{σ}_{s d 1}}{{σ}_{s}} - \frac{{σ}_{t d 1}}{{σ}_{t}} , \frac{{σ}_{s d 2}}{{σ}_{s}} - \frac{{σ}_{t d 2}}{{σ}_{t}} , \frac{{σ}_{s d 3}}{{σ}_{s}} - \frac{{σ}_{t d 3}}{{σ}_{t}} , … \frac{{σ}_{sdj}}{{σ}_{s}} - \frac{{σ}_{tdj}}{{σ}_{t}} \} - Min \{ \frac{{σ}_{s d 1}}{{σ}_{s}} - \frac{{σ}_{t d 1}}{{σ}_{t}} , \frac{{σ}_{s d 2}}{{σ}_{s}} - \frac{{σ}_{t d 2}}{{σ}_{t}} , \frac{{σ}_{s d 3}}{{σ}_{s}} - \frac{{σ}_{t d 3}}{{σ}_{t}} , … \frac{{σ}_{sdj}}{{σ}_{s}} - \frac{{σ}_{tdj}}{{σ}_{t}} \}$$

when the local crushing feature region is the compressive-tensile crushing region:

$$LSCT = Max \{ \frac{{σ}_{u c d 1}}{{σ}_{u c}} - \frac{{σ}_{t d 1}}{{σ}_{t}} , \frac{{σ}_{u c d 2}}{{σ}_{u c}} - \frac{{σ}_{t d 2}}{{σ}_{t}} , \frac{{σ}_{u c d 3}}{{σ}_{u c}} - \frac{{σ}_{t d 3}}{{σ}_{t}} , … \frac{{σ}_{u c d q}}{{σ}_{u c}} - \frac{{σ}_{t d q}}{{σ}_{t}} \} - Min \{ \frac{{σ}_{u c d 1}}{{σ}_{u c}} - \frac{{σ}_{t d 1}}{{σ}_{t}} , \frac{{σ}_{u c d 2}}{{σ}_{u c}} - \frac{{σ}_{t d 2}}{{σ}_{t}} , \frac{{σ}_{u c d 3}}{{σ}_{u c}} - \frac{{σ}_{t d 3}}{{σ}_{t}} , … \frac{{σ}_{u c d q}}{{σ}_{u c}} - \frac{{σ}_{t d q}}{{σ}_{t}} \}$$

wherein LSC is the strength mode factor when the local crushing feature region is the compressive crushing region, dimensionless; LSS is the strength mode factor when the local crushing feature region is the shear crushing region, dimensionless; LST is the strength mode factor when the local crushing feature region is the tensile crushing region, dimensionless; LSCS is the strength mode factor when the local crushing feature region is the compressive-shear crushing region, dimensionless; LSST is the strength mode factor when the local crushing feature region is the shear-tensile crushing region, dimensionless; LSCT is the strength mode factor when the local crushing feature region is the compressive-tensile crushing region, dimensionless; k is the number of the cutting tooth when the local crushing feature region is the compressive crushing region, dimensionless; l is the number of the cutting tooth when the local crushing feature region is the shear crushing region, dimensionless; n is the number of the cutting tooth when the local crushing feature region is the tensile crushing region, dimensionless; m is the number of the cutting tooth when the local crushing feature region is the compressive-shear crushing region, dimensionless; j is the number of the cutting tooth when the local crushing feature region is the shear-tensile crushing region, dimensionless; q is the number of the cutting tooth when the local crushing feature region is the compressive-tensile crushing region, dimensionless; σ_{uc} is the static rock uniaxial compressive strength, MPa; σₜ is the static rock tensile strength, MPa; σₛ is the static rock shear strength, MPa; σ_{ucd} is the dynamic rock uniaxial compressive strength, MPa; σ_{td} is the dynamic rock tensile strength, MPa; σ_{sd} is the dynamic rock shear strength, MPa.

Further, the drill bit tooth parameters are an inclination angle and a spatial position of the drill bit tooth; in the Step S4, the adjusting the difference among the strength mode factors of the local crushing feature region includes:

when the local crushing feature region is the compressive crushing region:

ΔLSC≤20%

when the local crushing feature region is the shear crushing region:

ΔLSS≤20%

when the local crushing feature region is the tensile crushing region:

ΔLST≤20%

when the local crushing feature region is the compressive-shear crushing region:

ΔLSCS≤25%

when the local crushing feature region is the shear-tensile crushing region:

ΔLSST≤25%

when the local crushing feature region is the compressive-tensile crushing region:

ΔLSCT≤25%

wherein ΔLSC is the difference among the strength mode factors when the local crushing feature region is the compressive crushing region, dimensionless; ΔLSS is the difference among the strength mode factors when the local crushing feature region is the shear crushing region, dimensionless; ΔLST is the difference among the strength mode factors when the local crushing feature region is the tensile crushing region, dimensionless; ΔLSCS is the difference among the strength mode factors when the local crushing feature region is the compressive-shear crushing region, dimensionless; ΔLSST is the difference among the strength mode factors when the local crushing feature region is the shear-tensile crushing region, dimensionless; ΔLSCT is the difference among the strength mode factors when the local crushing feature region is the compressive-tensile crushing region, dimensionless.

### The Invention has the Beneficial Effects

In the invention, it is considered that an optimized drill bit design method is established based on rock crushing principle with local variable strength. In the invention, the strength experienced by each symmetrical group of main cutting tooth on the drill bit is fully considered; (1) the drill bit is divided into local crushing feature regions as a whole; (2) strength mode factors of the local crushing feature regions are calculated; (3) a different among the strength mode factors of the local crushing feature regions is obtained to obtain a vector sum of horizontal cutting forces of the drill bit tooth corresponding to the same group of cutting tooth on the drill bit; (4) treating the difference among the strength mode factors of the local crushing feature region as a target control condition for drill bit design. In this method, based on the rock crushing principle with local variable strength, after dividing the symmetrical cutting tooth into groups, the strength variation factors of the symmetrical position are adjusted and balanced, and the strength of different symmetrical positions on the drill bit can be adjusted to be different, so that the rock crushing strength of different local crushing feature regions can be changed in a targeted manner, and the failure of the drill bit caused by the inability to control the strength of each main cutting tooth of the traditional drill bit by region is eliminated, thereby improving the rock crushing efficiency of the drill bit, prolonging the service time and having broad application prospects.

### BRIEF DESCRIPTION OF THE DRAWINGS

Upon reading the following detailed description of preferred embodiments, various advantages and benefits will be apparent to those of ordinary skill in the art. The drawings are for the purpose of explaining preferred embodiments only, and do not constitute improper limitations on the present invention. The same components are also denoted by the same reference numerals throughout the drawings. In the drawings:

FIG. 1 is a flow chart of a drill bit design method based on rock crushing principle with local variable strength according to an embodiment of the application.

### DESCRIPTION OF THE PREFERRED EMBODIMENTS

The invention will be further described below in conjunction with the accompanying drawings, and the protection scope of the invention is not limited to the following.

### Embodiment 1

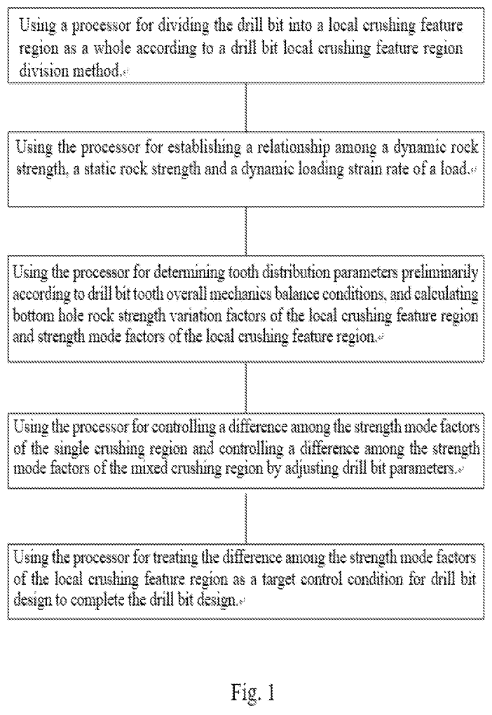

As shown in FIG. 1, a drill bit design method based on rock crushing principle with local variable strength includes the following steps:

Step S1: a type of a drill bit, a number of blades and a type of a drill bit tooth are selected, and the drill bit is divided into a local crushing feature region as a whole according to a drill bit local crushing feature region division method by a processor, wherein the local crushing feature region includes a single crushing region and a mixed crushing region.

In the Step S1, the type of the drill bit includes a PDC drill bit and a PDC-roller-cone compact drill bit; the number of blades includes a PDC drill bit with 4 blades, a PDC drill bit with 5 blades, a PDC drill bit with 6 blades, a PDC-roller-cone compact drill bit with 4 blades and a PDC-roller-cone compact drill bit with 6 blades, wherein the PDC-roller-cone compact drill bit with 4 blades is a roller-cone with 2 blades plus PDC with 2 blades, and the PDC-roller-cone compact drill bit with 6 blades includes a roller-cone with 2 blades plus PDC with 4 blades and a roller-cone with 3 blades plus PDC with 3 blades; the type of drill bit tooth includes a plane cutting tooth and a tapered cutting tooth.

In the Step S1, the drill bit tooth local crushing feature region division method specifically includes the following steps:

symmetrical blades of the PDC drill bit with an even number of blades are classified into one group, and the drill bit tooth of the same type in each group of blades are divided into the local crushing feature region; the drill bit tooth of the same type of the PDC drill bit with an odd number of blades are divided into the local crushing feature region; PDC blades of the PDC-roller-cone compact drill bit are classified into the same group, the roller-cone blades are divided into the same group, and the drill bit tooth of the same type in each group are divided into the local crushing feature region.

In the Step S1, the single crushing region includes a compressive crushing region, a shear crushing region and a tensile crushing region; the mixed crushing region is divided into a compressive-shear crushing region, a shear-tensile crushing region and a compressive-tensile crushing region.

Step S2: a relationship among a dynamic rock uniaxial compressive strength, a static rock uniaxial compressive strength and a dynamic loading strain rate of a load is established by the processor; a relationship among a dynamic rock tensile strength, a static rock tensile strength and the dynamic loading strain rate of the load is established by the processor; a relationship among a dynamic rock shear strength, a static rock shear strength and the dynamic loading strain rate of the load is established by the processor.

In the Step S2, the method of using the processor for establishing the relationship among the dynamic rock uniaxial compressive strength, the static rock uniaxial compressive strength and the dynamic loading strain rate of the load specifically includes the following steps: the dynamic rock uniaxial compressive strength is measured by a split Hopkinson pressure bar (HSPB) rock mechanics experiment machine, and a curve fit is performed on a ratio between the dynamic rock uniaxial compressive strength and the static rock uniaxial compressive strength and the dynamic loading strain rate of the load, so as to finally establish a relationship among the dynamic rock uniaxial compressive strength, the static rock uniaxial compressive strength and the dynamic loading strain rate of the load by the processor, which is specifically expressed as follows:

$$\frac{{σ}_{ucd}}{{σ}_{uc}} = \{ \begin{matrix}{a}_{1} {\dot{ε}}^{1 / ( 1 + {n}_{c} )} ( \dot{ε} < {\dot{ε}}^{*} ) \\ {a}_{2} {\dot{ε}}^{1 / n} ( \dot{ε} \geq {\dot{ε}}^{*} )\end{matrix}$$

In the Step S2, the method of using the processor for establishing the relationship among the dynamic rock tensile strength, the static rock tensile strength and the dynamic loading strain rate of the load specifically includes the following steps: the dynamic rock tensile strength is measured by the SHPB rock mechanics experiment machine, and a curve fit is performed on a ratio between the dynamic rock tensile strength and the static rock tensile strength and the dynamic loading strain rate of the load, so as to finally establish a relationship among the dynamic rock tensile strength, the static rock tensile strength and the dynamic loading strain rate of the load by the processor, which is specifically expressed as follows:

$$\frac{{σ}_{td}}{{σ}_{t}} = \{ \begin{matrix}{b}_{1} {\dot{ε}}^{1 / ( 1 + {n}_{c} )} ( \dot{ε} < {\dot{ε}}^{*} ) \\ {b}_{2} {\dot{ε}}^{1 / n} ( \dot{ε} \geq {\dot{ε}}^{*} )\end{matrix}$$

In the Step S2, the method of using the processor for establishing the relationship among the dynamic rock shear strength, the static rock shear strength and the dynamic loading strain rate of the load specifically includes the following steps: the dynamic rock shear strength is measured by the SHPB rock mechanics experiment machine, and a curve fit is performed on a ratio between the dynamic rock shear strength and the static rock shear strength and the dynamic loading strain rate of the load, so as to finally establish a relationship among the dynamic rock shear strength, the static rock shear strength and the dynamic loading strain rate of the load by the processor, which is specifically expressed as follows:

$$\frac{{σ}_{sd}}{{σ}_{s}} = \{ \begin{matrix}{c}_{1} {\dot{ε}}^{1 / ( 1 + {n}_{c} )} ( \dot{ε} < {\dot{ε}}^{*} ) \\ {c}_{2} {\dot{ε}}^{1 / n} ( \dot{ε} \geq {\dot{ε}}^{*} )\end{matrix}$$

wherein a₁, a₂, b₁, b₂, c₁, c₂, n, n_{c} are fit coefficients, dimensionless; σ_{uc} is the static rock uniaxial compressive strength, MPa; σₜ is the static rock tensile strength, MPa; σₛ is the static rock shear strength, MPa; σ_{ucd} is the dynamic rock uniaxial compressive strength, MPa; σ_{td} is the dynamic rock tensile strength, MPa; σ_{sd} is the dynamic rock shear strength, MPa; \dot{ε} is the dynamic loading strain rate of the load, s⁻¹; \dot{ε}* is the dynamic loading critical strain rate of the load, s⁻¹.

A calculation method of the dynamic loading strain rate of the load \dot{ε} in the process of crushing rocks with the drill bit tooth is expressed as follows:

$$\dot{ε} = \frac{1.4 {v}_{c} sin γ}{d sin ( γ + ω )}$$

wherein \dot{ε} is the dynamic loading strain rate of the load, s⁻¹; v_{c} is the cutting tooth speed, mm/s; d is the cutting depth, mm; γ is the drill bit tooth caster angle, rad; ω is the scrap forming-compaction transition angle, rad.

The cutting speed v_{ci} of the ith main cutting tooth on the drill bit is expressed as follows:

$${v}_{ci} = \frac{π {r}_{i} {RPM}_{n}}{30}$$

wherein rᵢ is a distance from a position where the ith main cutting tooth on the drill bit is located to an axis of the drill bit, m; RPMₙ is the rotating speed of the cutting tooth on the drill bit, r/min; v_{ci} is the cutting speed of the ith cutting tooth on the drill bit, m/s.

Step S3: tooth distribution parameters are determined preliminarily according to drill bit tooth overall mechanics balance conditions by the processor, and bottom hole rock strength variation factors of the local crushing feature region and strength mode factors of the local crushing feature region are calculated according to the tooth distribution parameters of the drill bit and the relationship among the dynamic rock uniaxial compressive strength, the static rock uniaxial compressive strength and a dynamic loading strain rate of the load, the relationship among the dynamic rock tensile strength, the static rock tensile strength and the dynamic loading strain rate of the load and the relationship among the dynamic rock shear strength, the static rock shear strength and the dynamic loading strain rate of the load established in the Step S2.

In the Step S3, the tooth distribution parameters include the number of drill bit tooth, a diameter of each of the drill bit tooth, a caster angle of each of the drill bit tooth, and a distance from a position where each of the main cutting tooth is located to the axis of the drill bit.

In the Step S3, the method of calculating bottom hole rock strength variation factors of the local crushing feature region specifically includes the following steps: a relationship between the bottom hole rock strength variation factors and the drill bit tooth distribution parameters corresponding to each of the main cutting tooth is obtained by the curve fit method according to the relationship among the dynamic rock uniaxial compressive strength, the static rock uniaxial compressive strength and the dynamic loading strain rate of the load, the relationship among the dynamic rock tensile strength, the static rock tensile strength and the dynamic loading strain rate of the load and the relationship among the dynamic rock shear strength, the static rock shear strength and the dynamic loading strain rate of the load obtained in the Step S2, which is specifically expressed as follows:

$$\begin{matrix}\frac{{σ}_{ucdi}}{{σ}_{uc}} = \{ \begin{matrix}{a}_{1 i} {v}_{ci} \cdot {\frac{1.4 sin γ}{d sin ( γ + ω )}}^{1 / ( 1 + {n}_{ci} )} ( \dot{ε} < {\dot{ε}}^{*} ) \\ {a}_{2 i} {v}_{ci} \cdot {\frac{1.4 sin γ}{d sin ( γ + ω )}}^{1 / {n}_{i}} ( \dot{ε} \geq {\dot{ε}}^{*} )\end{matrix} \\ \frac{{σ}_{sdi}}{{σ}_{s}} = \{ \begin{matrix}{b}_{1 i} {v}_{ci} \cdot {\frac{1.4 sin γ}{d sin ( γ + ω )}}^{1 / ( 1 + {n}_{ci} )} ( \dot{ε} < {\dot{ε}}^{*} ) \\ {b}_{2 i} {v}_{ci} \cdot {\frac{1.4 sin γ}{d sin ( γ + ω )}}^{1 / {n}_{i}} ( \dot{ε} \geq {\dot{ε}}^{*} )\end{matrix} \\ \frac{{σ}_{tdi}}{{σ}_{t}} = \{ \begin{matrix}{c}_{1 i} {v}_{ci} \cdot {\frac{1.4 sin γ}{d sin ( γ + ω )}}^{1 / ( 1 + {n}_{ci} )} ( \dot{ε} < {\dot{ε}}^{*} ) \\ {c}_{2 i} {v}_{ci} \cdot {\frac{1.4 sin γ}{d sin ( γ + ω )}}^{1 / {n}_{i}} ( \dot{ε} \geq {\dot{ε}}^{*} )\end{matrix}\end{matrix}$$

wherein a₁ᵢ, a₂ᵢ, b₁ᵢ, b₂ᵢ, c₁ᵢ, c₂ᵢ, nᵢ, n_{ci} are fit coefficients of the strength variation factor expression corresponding to the ith cutting tooth on the drill bit, dimensionless; σ_{ucdi} is the dynamic uniaxial compressive strength in the process of dynamically crushing rocks of the ith cutting tooth on the drill bit, MPa;

$$\frac{{σ}_{ucdi}}{{σ}_{uc}}$$

is the ratio between the dynamic uniaxial compressive strength and the static uniaxial compressive strength in the process of dynamically crushing rocks of the i th cutting tooth on the drill bit, compressive strength variation factors for short, dimensionless; σ_{sdi} is the dynamic shear strength in the process of dynamically crushing rocks of the ith cutting tooth on the drill bit, MPa;

$$\frac{{σ}_{sdi}}{{σ}_{s}}$$

is the ratio between the dynamic shear strength and the static shear strength in the process of dynamically crushing rocks of the ith cutting tooth on the drill bit, shear strength variation factors for short, dimensionless; σ_{tdi} is the dynamic tensile strength in the process of dynamically crushing rocks of the ith cutting tooth on the drill bit, MPa;

$$\frac{{σ}_{tdi}}{{σ}_{t}}$$

is the ratio between the dynamic tensile strength and the static tensile strength in the process of dynamically crushing rocks of the ith cutting tooth on the drill bit, tensile strength variation factors for short, dimensionless; σ_{uc} is the static rock uniaxial compressive strength, MPa; σₜ is the static rock tensile strength, MPa; σₛ is the static rock shear strength, MPa; v_{ci} is the cutting speed of the ith cutting tooth on the drill bit, m/s; d is the cutting depth, mm; γ is the caster angle of the drill bit tooth, rad; ω is the scrap forming-compaction transition angle, rad; \dot{ε}* is the dynamic loading critical strain rate of the load, s⁻¹.

In the Step S3, a method of calculating the strength mode factors of the local crushing feature region includes the following steps:

when the local crushing feature region is the compressive crushing region:

$$LSC = Max \{ \frac{{σ}_{ucd 1}}{{σ}_{uc}} , \frac{{σ}_{ucd 2}}{{σ}_{uc}} , \frac{{σ}_{ucd 3}}{{σ}_{uc}} … \frac{{σ}_{ucdk}}{{σ}_{uc}} \} - Min \{ \frac{{σ}_{ucd 1}}{{σ}_{uc}} , \frac{{σ}_{ucd 2}}{{σ}_{uc}} , \frac{{σ}_{ucd 3}}{{σ}_{uc}} … \frac{{σ}_{ucdk}}{{σ}_{uc}} \}$$

when the local crushing feature region is the shear crushing region:

$$LSS = Max \{ \frac{{σ}_{sd 1}}{{σ}_{s}} , \frac{{σ}_{sd 2}}{{σ}_{s}} , \frac{{σ}_{sd 3}}{{σ}_{s}} … \frac{{σ}_{sdl}}{{σ}_{s}} \} - Min \{ \frac{{σ}_{sd 1}}{{σ}_{s}} , \frac{{σ}_{sd 2}}{{σ}_{s}} , \frac{{σ}_{sd 3}}{{σ}_{s}} … \frac{{σ}_{sdl}}{{σ}_{s}} \}$$

when the local crushing feature region is the tensile crushing region:

$$LST = Max \{ \frac{{σ}_{td 1}}{{σ}_{t}} , \frac{{σ}_{td 2}}{{σ}_{t}} , \frac{{σ}_{td 3}}{{σ}_{t}} … \frac{{σ}_{tdn}}{{σ}_{t}} \} - Min \{ \frac{{σ}_{td 1}}{{σ}_{t}} , \frac{{σ}_{td 2}}{{σ}_{t}} , \frac{{σ}_{td 3}}{{σ}_{t}} … \frac{{σ}_{tdn}}{{σ}_{t}} \}$$

when the local crushing feature region is the compressive-shear crushing region:

$$LSCS = Max \{ \frac{{σ}_{ucd 1}}{{σ}_{uc}} - \frac{{σ}_{sd 1}}{{σ}_{s}} , \frac{{σ}_{ucd 2}}{{σ}_{uc}} - \frac{{σ}_{sd 2}}{{σ}_{s}} , \frac{{σ}_{ucd 3}}{{σ}_{uc}} - \frac{{σ}_{sd 3}}{{σ}_{s}} , … \frac{{σ}_{ucdk}}{{σ}_{uc}} - \frac{{σ}_{sdm}}{{σ}_{s}} \} - Min \{ \frac{{σ}_{ucd 1}}{{σ}_{uc}} - \frac{{σ}_{sd 1}}{{σ}_{s}} , \frac{{σ}_{ucd 2}}{{σ}_{uc}} - \frac{{σ}_{sd 2}}{{σ}_{s}} , \frac{{σ}_{ucd 3}}{{σ}_{uc}} - \frac{{σ}_{sd 3}}{{σ}_{s}} , … \frac{{σ}_{ucdk}}{{σ}_{uc}} - \frac{{σ}_{sdm}}{{σ}_{s}} \}$$

when the local crushing feature region is the shear-tensile crushing region:

$$LSST = Max \{ \frac{{σ}_{sd 1}}{{σ}_{s}} - \frac{{σ}_{td 1}}{{σ}_{t}} , \frac{{σ}_{sd 2}}{{σ}_{s}} - \frac{{σ}_{td 2}}{{σ}_{t}} , \frac{{σ}_{sd 3}}{{σ}_{s}} - \frac{{σ}_{td 3}}{{σ}_{t}} , … \frac{{σ}_{sdj}}{{σ}_{s}} - \frac{{σ}_{tdj}}{{σ}_{t}} \} - Min \{ \frac{{σ}_{sd 1}}{{σ}_{s}} - \frac{{σ}_{td 1}}{{σ}_{t}} , \frac{{σ}_{sd 2}}{{σ}_{s}} - \frac{{σ}_{td 2}}{{σ}_{t}} , \frac{{σ}_{sd 3}}{{σ}_{s}} - \frac{{σ}_{td 3}}{{σ}_{t}} , … \frac{{σ}_{sdj}}{{σ}_{s}} - \frac{{σ}_{tdj}}{{σ}_{t}} \}$$

when the local crushing feature region is the compressive-tensile crushing region:

$$LSCT = Max \{ \frac{{σ}_{ucd 1}}{{σ}_{uc}} - \frac{{σ}_{td 1}}{{σ}_{t}} , \frac{{σ}_{ucd 2}}{{σ}_{uc}} - \frac{{σ}_{td 2}}{{σ}_{t}} , \frac{{σ}_{ucd 3}}{{σ}_{uc}} - \frac{{σ}_{td 3}}{{σ}_{t}} , … \frac{{σ}_{ucdq}}{{σ}_{uc}} - \frac{{σ}_{tdq}}{{σ}_{t}} \} - Min \{ \frac{{σ}_{ucd 1}}{{σ}_{uc}} - \frac{{σ}_{td 1}}{{σ}_{t}} , \frac{{σ}_{ucd 2}}{{σ}_{uc}} - \frac{{σ}_{td 2}}{{σ}_{t}} , \frac{{σ}_{ucd 3}}{{σ}_{uc}} - \frac{{σ}_{td 3}}{{σ}_{t}} , … \frac{{σ}_{ucdq}}{{σ}_{uc}} - \frac{{σ}_{tdq}}{{σ}_{t}} \}$$

wherein LSC is the strength mode factor when the local crushing feature region is the compressive crushing region, dimensionless; LSS is the strength mode factor when the local crushing feature region is the shear crushing region, dimensionless; LST is the strength mode factor when the local crushing feature region is the tensile crushing region, dimensionless; LSCS is the strength mode factor when the local crushing feature region is the compressive-shear crushing region, dimensionless; LSST is the strength mode factor when the local crushing feature region is the shear-tensile crushing region, dimensionless; LSCT is the strength mode factor when the local crushing feature region is the compressive-tensile crushing region, dimensionless; k is the number of the cutting tooth when the local crushing feature region is the compressive crushing region, dimensionless; l is the number of the cutting tooth when the local crushing feature region is the shear crushing region, dimensionless; n is the number of the cutting tooth when the local crushing feature region is the tensile crushing region, dimensionless; m is the number of the cutting tooth when the local crushing feature region is the compressive-shear crushing region, dimensionless; j is the number of the cutting tooth when the local crushing feature region is the shear-tensile crushing region, dimensionless; q is the number of the cutting tooth when the local crushing feature region is the compressive-tensile crushing region, dimensionless; σ_{uc} is the static rock uniaxial compressive strength, MPa; σₜ is the static rock tensile strength, MPa; σₛ is the static rock shear strength, MPa; σ_{ucd} is the dynamic rock uniaxial compressive strength, MPa; σ_{td} is the dynamic rock tensile strength, MPa; σ_{sd} is the dynamic rock shear strength, MPa.

Step S4: a difference among the strength mode factors of the single crushing region is controlled within 20% and a difference among the strength mode factors of the mixed crushing region is controlled within 25% by adjusting drill bit parameters and regulating a difference among the strength mode factors of the local crushing feature region by the processor in the Step S3.

The drill bit tooth parameters are an inclination angle and a spatial position of the drill bit tooth; in the Step S4, the adjusting the difference among the strength mode factors of the local crushing feature region includes the following steps:

when the local crushing feature region is the compressive crushing region:

ΔLSC≤20%

when the local crushing feature region is the shear crushing region:

ΔLSS≤20%

when the local crushing feature region is the tensile crushing region:

ΔLST≤20%

when the local crushing feature region is the compressive-shear crushing region:

ΔLSCS≤25%

when the local crushing feature region is the shear-tensile crushing region:

ΔLSST≤25%

when the local crushing feature region is the compressive-tensile crushing region:

ΔLSCT≤25%

wherein ΔLSC is the difference among the strength mode factors when the local crushing feature region is the compressive crushing region, dimensionless; ΔLSS is the difference among the strength mode factors when the local crushing feature region is the shear crushing region, dimensionless; ΔLST is the difference among the strength mode factors when the local crushing feature region is the tensile crushing region, dimensionless; ΔLSCS is the difference among the strength mode factors when the local crushing feature region is the compressive-shear crushing region, dimensionless; ΔLSST is the difference among the strength mode factors when the local crushing feature region is the shear-tensile crushing region, dimensionless; ΔLSCT is the difference among the strength mode factors when the local crushing feature region is the compressive-tensile crushing region, dimensionless.

Step S5: the difference among the strength mode factors of the local crushing feature region obtained in the Step S4 is treated as a target control condition for drill bit design by the processor, wherein the drill bit design is completed if the target control condition for drill bit design is met, and the drill bit tooth distribution parameters are continued to be adjusted to meet the target control condition for drill bit design to complete the drill bit design if the target control condition for drill bit design is not met.

The invention discloses a drill bit design method based on rock crushing principle with local variable strength. The method includes: first, the drill bit is divided into local crushing feature regions as a whole; then, strength mode factors of the local crushing feature regions are calculated; and then, a different among the strength mode factors of the local crushing feature regions is obtained to obtain a vector sum of horizontal cutting forces of the drill bit tooth corresponding to the same group of cutting tooth on the drill bit; finally, treating the difference among the strength mode factors of the local crushing feature region as a target control condition for drill bit design. In this method, based on the rock crushing principle with local variable strength, after dividing the symmetrical cutting tooth into groups, the strength variation factors of the symmetrical position are adjusted and balanced, and the strength of different symmetrical positions on the drill bit can be adjusted to be different, so that the rock crushing strength of different local crushing feature regions can be changed in a targeted manner, and the failure of the drill bit caused by the inability to control the strength of each main cutting tooth of the traditional drill bit by region is eliminated, thereby improving the rock crushing efficiency of the drill bit, prolonging the service time and having broad application prospects.

So far, those skilled in the art realize that although embodiments of the invention have been shown and described in detail herein, numerous other variations or modifications consistent with the principles of the invention may be directly determined or derived from the disclosure without departing from the spirit and scope of the invention. Accordingly, the scope of the invention should be understood and deemed to cover all such other variations or modifications.

What is claimed is:

1. A drill bit design method based on rock crushing principle with local variable strength, comprising steps of:
Step S1: selecting a type of a drill bit, a number of blades and a type of a drill bit tooth, and using a processor for dividing the drill bit into a local crushing feature region as a whole according to a drill bit local crushing feature region division method, wherein the local crushing feature region comprises a single crushing region and a mixed crushing region;
Step S2: using the processor for establishing a relationship among a dynamic rock uniaxial compressive strength, a static rock uniaxial compressive strength and a dynamic loading strain rate of a load; establishing a relationship among a dynamic rock tensile strength, a static rock tensile strength and the dynamic loading strain rate of the load; using the processor for establishing a relationship among a dynamic rock shear strength, a static rock shear strength and the dynamic loading strain rate of the load;
Step S3: using the processor for determining tooth distribution parameters preliminarily according to drill bit tooth overall mechanics balance conditions, and calculating bottom hole rock strength variation factors of the local crushing feature region and strength mode factors of the local crushing feature region according to the tooth distribution parameters of the drill bit and the relationship among the dynamic rock uniaxial compressive strength, the static rock uniaxial compressive strength and a dynamic loading strain rate of the load, the relationship among the dynamic rock tensile strength, the static rock tensile strength and the dynamic loading strain rate of the load and the relationship among the dynamic rock shear strength, the static rock shear strength and the dynamic loading strain rate of the load established in the Step S2;
Step S4: using the processor for controlling a difference among the strength mode factors of the single crushing region within 20% and controlling a difference among the strength mode factors of the mixed crushing region within 25% by adjusting drill bit parameters and regulating a difference among the strength mode factors of the local crushing feature region in the Step S3;
Step S5: using the processor for treating the difference among the strength mode factors of the local crushing feature region obtained in the Step S4 as a target control condition for drill bit design, wherein the drill bit design is completed if the target control condition for drill bit design is met, and the drill bit tooth distribution parameters are continued to be adjusted to meet the target control condition for drill bit design to complete the drill bit design if the target control condition for drill bit design is not met.

2. The drill bit design method based on rock crushing principle with local variable strength according to claim 1, wherein in the Step S1, the type of the drill bit comprises a PDC drill bit and a PDC-roller-cone compact drill bit; the number of blades comprises a PDC drill bit with 4 blades, a PDC drill bit with 5 blades, a PDC drill bit with 6 blades, a PDC-roller-cone compact drill bit with 4 blades and a PDC-roller-cone compact drill bit with 6 blades, wherein the PDC-roller-cone compact drill bit with 4 blades is a roller-cone with 2 blades plus PDC with 2 blades, and the PDC-roller-cone compact drill bit with 6 blades comprises a roller-cone with 2 blades plus PDC with 4 blades and a roller-cone with 3 blades plus PDC with 3 blades; the type of the drill bit tooth comprises a plane cutting tooth and a tapered cutting tooth.

3. The drill bit design method based on rock crushing principle with local variable strength according to claim 1, wherein in the Step S1, the drill bit tooth local crushing feature region division method specifically comprises:
using the processor for classifying symmetrical blades of the PDC drill bit with an even number of blades into one group, and dividing the drill bit tooth of the same type in each group of blades into the local crushing feature region; dividing the drill bit tooth of the same type of the PDC drill bit with an odd number of blades into the local crushing feature region; using the processor for classifying PDC blades of the PDC-roller-cone compact drill bit into the same group, dividing the roller-cone blades into the same group, and dividing the drill bit tooth of the same type in each group into the local crushing feature region.

4. The drill bit design method based on rock crushing principle with local variable strength according to claim 1, wherein in the Step S1, the single crushing region comprises a compressive crushing region, a shear crushing region and a tensile crushing region; the mixed crushing region is divided into a compressive-shear crushing region, a shear-tensile crushing region and a compressive-tensile crushing region.

5. The drill bit design method based on rock crushing principle with local variable strength according to claim 1, wherein in the Step S2, the method of using the processor for establishing the relationship among the dynamic rock uniaxial compressive strength, the static rock uniaxial compressive strength and the dynamic loading strain rate of the load specifically comprises: using the processor for measuring the dynamic rock uniaxial compressive strength by a split Hopkinson pressure bar (SHPB) rock mechanics experiment machine, and performing a curve fit on a ratio between the dynamic rock uniaxial compressive strength and the static rock uniaxial compressive strength and the dynamic loading strain rate of the load, so as to finally establish the relationship among the dynamic rock uniaxial compressive strength, the static rock uniaxial compressive strength and the dynamic loading strain rate of the load, which is specifically expressed as follows:
$$\frac{{σ}_{u c d}}{{σ}_{u c}} = \{ \begin{matrix}{a}_{1} {\dot{ε}}^{1 / ( 1 + {n}_{c} )} ( \dot{ε} < {\dot{ε}}^{*} ) \\ {a}_{2} {\dot{ε}}^{1 / n} ( \dot{ε} \geq {\dot{ε}}^{*} )\end{matrix}$$
in the Step S2, the method of using the processor for establishing the relationship among the dynamic rock tensile strength, the static rock tensile strength and the dynamic loading strain rate of the load specifically comprises: measuring the dynamic rock tensile strength by the SHPB rock mechanics experiment machine, and performing a curve fit on a ratio between the dynamic rock tensile strength and the static rock tensile strength and the dynamic loading strain rate of the load, so as to finally establish a relationship among the dynamic rock tensile strength, the static rock tensile strength and the dynamic loading strain rate of the load, which is specifically expressed as follows:
$$\frac{{σ}_{t d}}{{σ}_{t}} = \{ \begin{matrix}{b}_{1} {\dot{ε}}^{1 / ( 1 + {n}_{c} )} ( \dot{ε} < {\dot{ε}}^{*} ) \\ {b}_{2} {\dot{ε}}^{1 / n} ( \dot{ε} \geq {\dot{ε}}^{*} )\end{matrix}$$
in the Step S2, the method of using the processor for establishing the relationship among the dynamic rock shear strength, the static rock shear strength and the dynamic loading strain rate of the load specifically comprises: measuring the dynamic rock shear strength by the SHPB rock mechanics experiment machine, and performing a curve fit on a ratio between the dynamic rock shear strength and the static rock shear strength and the dynamic loading strain rate of the load, so as to finally establish a relationship among the dynamic rock shear strength, the static rock shear strength and the dynamic loading strain rate of the load, which is specifically expressed as follows:
$$\frac{{σ}_{s d}}{{σ}_{s}} = \{ \begin{matrix}{c}_{1} {\dot{ε}}^{1 / ( 1 + {n}_{c} )} ( \dot{ε} < {\dot{ε}}^{*} ) \\ {c}_{2} {\dot{ε}}^{1 / n} ( \dot{ε} \geq {\dot{ε}}^{*} )\end{matrix}$$
wherein a₁, a₂, b₁, b₂, c₁, c₂, n, n_{c} are fit coefficients, dimensionless; σ_{uc} is the static rock uniaxial compressive strength, MPa; σₜ is the static rock tensile strength, MPa; σₛ is the static rock shear strength, MPa; σ_{ucd} is the dynamic rock uniaxial compressive strength, MPa; σ_{td} is the dynamic rock tensile strength, MPa; σ_{sd} is the dynamic rock shear strength, MPa; \dot{ε} is the dynamic loading strain rate of the load, s⁻¹; \dot{ε}* is the dynamic loading critical strain rate of the load, s⁻¹.

6. The drill bit design method based on rock crushing principle with local variable strength according to claim 5, wherein a calculation method of the dynamic loading strain rate of the load \dot{ε} in the process of crushing rocks with the drill bit tooth is expressed as follows:
$$\dot{ε} = \frac{1.4 {v}_{c} sin γ}{d sin ( γ + ω )}$$
wherein \dot{ε} is the dynamic loading strain rate of the load, s⁻¹; v_{c} is the cutting tooth speed, mm/s; d is the cutting depth, mm; γ is the drill bit tooth caster angle, rad; ω is the scrap forming-compaction transition angle, rad;
the cutting speed v_{ci} of the ith main cutting tooth on the drill bit is expressed as follows:
$${v}_{c i} = \frac{π {r}_{i} R P {M}_{n}}{30}$$
wherein rᵢ is a distance from a position where the ith main cutting tooth on the drill bit is located to an axis of the drill bit, m; RPM is the rotating speed of the cutting tooth on the drill bit, r/min; v_{ci} is the cutting speed of the ith cutting tooth on the drill bit, m/s.

7. The drill bit design method based on rock crushing principle with local variable strength according to claim 1, wherein in the Step S3, the tooth distribution parameters comprise the number of drill bit tooth, a diameter of each of the drill bit tooth, a caster angle of each of the drill bit tooth, and a distance from a position where each of the main cutting tooth is located to the axis of the drill bit.

8. The drill bit design method based on rock crushing principle with local variable strength according to claim 1, wherein in the Step S3, the method of calculating bottom hole rock strength variation factors of the local crushing feature region specifically comprises: using the processor for obtaining a relationship between the bottom hole rock strength variation factors and the drill bit tooth distribution parameters corresponding to each of the main cutting tooth by the curve fit method according to the relationship among the dynamic rock uniaxial compressive strength, the static rock uniaxial compressive strength and the dynamic loading strain rate of the load, the relationship among the dynamic rock tensile strength, the static rock tensile strength and the dynamic loading strain rate of the load and the relationship among the dynamic rock shear strength, the static rock shear strength and the dynamic loading strain rate of the load obtained in the Step S2, which is specifically expressed as follows:
$$\frac{{σ}_{u c d i}}{{σ}_{u c}} = \{ \begin{matrix}{a}_{1 i} {v}_{c i} \cdot {\frac{1.4 sin γ}{d sin ( γ + ω )}}^{1 / ( 1 + {n}_{c i} )} ( \dot{ε} < {\dot{ε}}^{*} ) \\ {a}_{2 i} {v}_{c i} \cdot {\frac{1.4 sin γ}{d sin ( γ + ω )}}^{1 / {n}_{i}} ( \dot{ε} \geq {\dot{ε}}^{*} )\end{matrix}$$
$$\frac{{σ}_{s d i}}{{σ}_{s}} = \{ \begin{matrix}{b}_{1 i} {v}_{c i} \cdot {\frac{1.4 sin γ}{d sin ( γ + ω )}}^{1 / ( 1 + {n}_{c i} )} ( \dot{ε} < {\dot{ε}}^{*} ) \\ {b}_{2 i} {v}_{c i} \cdot {\frac{1.4 sin γ}{d sin ( γ + ω )}}^{1 / {n}_{i}} ( \dot{ε} \geq {\dot{ε}}^{*} )\end{matrix}$$
$$\frac{{σ}_{t d i}}{{σ}_{t}} = \{ \begin{matrix}{c}_{1 i} {v}_{c i} \cdot {\frac{1.4 sin γ}{d sin ( γ + ω )}}^{1 / ( 1 + {n}_{c i} )} ( \dot{ε} < {\dot{ε}}^{*} ) \\ {c}_{2 i} {v}_{c i} \cdot {\frac{1.4 sin γ}{d sin ( γ + ω )}}^{1 / {n}_{i}} ( \dot{ε} \geq {\dot{ε}}^{*} )\end{matrix}$$
wherein a₁ᵢ, a₂ᵢ, b₁ᵢ, b₂ᵢ, c₁ᵢ, c₂ᵢ, n₁, n_{ci} are fit coefficients of the strength variation factor expression corresponding to the ith cutting tooth on the drill bit, dimensionless; σ_{ucdi} is the dynamic uniaxial compressive strength in the process of dynamically crushing rocks of the ith cutting tooth on the drill bit, MPa;
$$\frac{{σ}_{u c d i}}{{σ}_{u c}}$$
is the ratio between the dynamic uniaxial compressive strength and the static uniaxial compressive strength in the process of dynamically crushing rocks of the i th cutting tooth on the drill bit, compressive strength variation factors for short, dimensionless; σ_{sdi} is the dynamic shear strength in the process of dynamically crushing rocks of the ith cutting tooth on the drill bit, MPa;
$$\frac{{σ}_{s d i}}{{σ}_{s}}$$
is the ratio between the dynamic shear strength and the static shear strength in the process of dynamically crushing rocks of the ith cutting tooth on the drill bit, shear strength variation factors for short, dimensionless; σ_{tdi} is the dynamic tensile strength in the process of dynamically crushing rocks of the ith cutting tooth on the drill bit, MPa;
$$\frac{{σ}_{t d i}}{{σ}_{t}}$$
is the ratio between the dynamic tensile strength and the static tensile strength in the process of dynamically crushing rocks of the ith cutting tooth on the drill bit, tensile strength variation factors for short, dimensionless; σ_{uc} is the static rock uniaxial compressive strength, MPa; σₜ is the static rock tensile strength, MPa; σₛ is the static rock shear strength, MPa; v_{ci} is the cutting speed of the ith cutting tooth on the drill bit, m/s; d is the cutting depth, mm; γ is the caster angle of the drill bit tooth, rad; ω is the scrap forming-compaction transition angle, rad; \dot{ε}* is the dynamic loading critical strain rate of the load, s⁻¹.

9. The drill bit design method based on rock crushing principle with local variable strength according to claim 1, wherein in the Step S3, the method of calculating the strength mode factors of the local crushing feature region comprises:
when the local crushing feature region is the compressive crushing region:
$$LSC = Max \{ \begin{matrix}\frac{{σ}_{ucd 1}}{{σ}_{u c}} \cdot & \frac{{σ}_{ucd 2}}{{σ}_{u c}} \cdot & \frac{{σ}_{ucd 3}}{{σ}_{u c}} & … & \frac{{σ}_{ucdk}}{{σ}_{u c}}\end{matrix} \} - Min \{ \begin{matrix}\frac{{σ}_{ucd 1}}{{σ}_{u c}} \cdot & \frac{{σ}_{ucd 2}}{{σ}_{u c}} \cdot & \frac{{σ}_{ucd 3}}{{σ}_{u c}} & … & \frac{{σ}_{ucdk}}{{σ}_{u c}}\end{matrix} \}$$
when the local crushing feature region is the shear crushing region:
$$LSS = Max \{ \frac{{σ}_{s d 1}}{{σ}_{s}} \cdot \frac{{σ}_{s d 2}}{{σ}_{s}} \cdot \frac{{σ}_{s d 3}}{{σ}_{s}} … \frac{{σ}_{s d 1}}{{σ}_{s}} \} - Min \{ \frac{{σ}_{s d 1}}{{σ}_{s}} \cdot \frac{{σ}_{s d 2}}{{σ}_{s}} \cdot \frac{{σ}_{s d 3}}{{σ}_{s}} … \frac{{σ}_{s d 1}}{{σ}_{s}} \}$$
when the local crushing feature region is the tensile crushing region:
$$LST = Max \{ \frac{{σ}_{t d 1}}{{σ}_{t}} \cdot \frac{{σ}_{t d 2}}{{σ}_{t}} \cdot \frac{{σ}_{t d 3}}{{σ}_{t}} … \frac{{σ}_{t d n}}{{σ}_{t}} \} - Min \{ \frac{{σ}_{t d 1}}{{σ}_{t}} \cdot \frac{{σ}_{t d 2}}{{σ}_{t}} \cdot \frac{{σ}_{t d 3}}{{σ}_{t}} … \frac{{σ}_{t d n}}{{σ}_{t}} \}$$
when the local crushing feature region is the compressive-shear crushing region:
$$LSCS = Max \{ \frac{{σ}_{u c d 1}}{{σ}_{u c}} - \frac{{σ}_{s d 1}}{{σ}_{s}} \cdot \frac{{σ}_{ucd 2}}{{σ}_{u c}} - \frac{{σ}_{s d 2}}{{σ}_{s}} \cdot \frac{{σ}_{u c d 3}}{{σ}_{u c}} - \frac{{σ}_{s d 3}}{{σ}_{s}} \cdot ... \frac{{σ}_{u c d k}}{{σ}_{u c}} - \frac{{σ}_{s d m}}{{σ}_{s}} \} - Min \{ \frac{{σ}_{u c d 1}}{{σ}_{u c}} - \frac{{σ}_{s d 1}}{{σ}_{s}} \cdot \frac{{σ}_{ucd 2}}{{σ}_{u c}} - \frac{{σ}_{s d 2}}{{σ}_{s}} \cdot \frac{{σ}_{u c d 3}}{{σ}_{u c}} - \frac{{σ}_{s d 3}}{{σ}_{s}} \cdot ... \frac{{σ}_{u c d k}}{{σ}_{u c}} - \frac{{σ}_{s d m}}{{σ}_{s}} \}$$
when the local crushing feature region is the shear-tensile crushing region:
$$LSST = Max \{ \frac{{σ}_{s d 1}}{{σ}_{s}} - \frac{{σ}_{t d 1}}{{σ}_{t}} \cdot \frac{{σ}_{s d 2}}{{σ}_{s}} - \frac{{σ}_{t d 2}}{{σ}_{t}} \cdot \frac{{σ}_{s d 3}}{{σ}_{s}} - \frac{{σ}_{t d 3}}{{σ}_{t}} \cdot ... \frac{{σ}_{sdj}}{{σ}_{s}} - \frac{{σ}_{tdj}}{{σ}_{t}} \} - Min \{ \frac{{σ}_{s d 1}}{{σ}_{s}} - \frac{{σ}_{td 1}}{{σ}_{t}} \cdot \frac{{σ}_{s d 2}}{{σ}_{s}} - \frac{{σ}_{t d 2}}{{σ}_{t}} \cdot \frac{{σ}_{s d 3}}{{σ}_{s}} - \frac{{σ}_{t d 3}}{{σ}_{t}} \cdot ... \frac{{σ}_{sdj}}{{σ}_{s}} - \frac{{σ}_{tdj}}{{σ}_{t}} \}$$
when the local crushing feature region is the compressive-tensile crushing region:
$$LSCT = Max \{ \frac{{σ}_{u c d 1}}{{σ}_{u c}} - \frac{{σ}_{t d 1}}{{σ}_{t}} \cdot \frac{{σ}_{u c d 2}}{{σ}_{u c}} - \frac{{σ}_{t d 2}}{{σ}_{t}} \cdot \frac{{σ}_{u c d 3}}{{σ}_{u c}} - \frac{{σ}_{t d 3}}{{σ}_{t}} \cdot ... \frac{{σ}_{u c d q}}{{σ}_{u c}} - \frac{{σ}_{t d q}}{{σ}_{t}} \} - Min \{ \frac{{σ}_{u c d 1}}{{σ}_{u c}} - \frac{{σ}_{t d 1}}{{σ}_{t}} \cdot \frac{{σ}_{u c d 2}}{{σ}_{u c}} - \frac{{σ}_{t d 2}}{{σ}_{t}} \cdot \frac{{σ}_{u c d 3}}{{σ}_{u c}} - \frac{{σ}_{t d 3}}{{σ}_{t}} \cdot ... \frac{{σ}_{u c d q}}{{σ}_{u c}} - \frac{{σ}_{t d q}}{{σ}_{t}} \}$$
wherein LSC is the strength mode factor when the local crushing feature region is the compressive crushing region, dimensionless; LSS is the strength mode factor when the local crushing feature region is the shear crushing region, dimensionless; LST is the strength mode factor when the local crushing feature region is the tensile crushing region, dimensionless; LSCS is the strength mode factor when the local crushing feature region is the compressive-shear crushing region, dimensionless; LSST is the strength mode factor when the local crushing feature region is the shear-tensile crushing region, dimensionless; LSCT is the strength mode factor when the local crushing feature region is the compressive-tensile crushing region, dimensionless; k is the number of the cutting tooth when the local crushing feature region is the compressive crushing region, dimensionless; l is the number of the cutting tooth when the local crushing feature region is the shear crushing region, dimensionless; n is the number of the cutting tooth when the local crushing feature region is the tensile crushing region, dimensionless; m is the number of the cutting tooth when the local crushing feature region is the compressive-shear crushing region, dimensionless; j is the number of the cutting tooth when the local crushing feature region is the shear-tensile crushing region, dimensionless; q is the number of the cutting tooth when the local crushing feature region is the compressive-tensile crushing region, dimensionless; σ_{uc} is the static rock uniaxial compressive strength, MPa; σₜ is the static rock tensile strength, MPa; σₛ is the static rock shear strength, MPa; σ_{ucd} is the dynamic rock uniaxial compressive strength, MPa; σ_{td} is the dynamic rock tensile strength, MPa; σ_{sd} is the dynamic rock shear strength, MPa.

10. The drill bit design method based on rock crushing principle with local variable strength according to claim 1, wherein the drill bit tooth parameters are an inclination angle and a spatial position of the drill bit tooth; in the Step S4, the adjusting the difference among the strength mode factors of the local crushing feature region comprises:
when the local crushing feature region is the compressive crushing region:
ΔLSC≤20%
when the local crushing feature region is the shear crushing region:
ΔLSS≤20%
when the local crushing feature region is the tensile crushing region:
ΔLST≤20%
when the local crushing feature region is the compressive-shear crushing region:
ΔLSCS≤25%
when the local crushing feature region is the shear-tensile crushing region:
ΔLSST≤25%
when the local crushing feature region is the compressive-tensile crushing region:
ΔLSCT≤25%
wherein ΔLSC is the difference among the strength mode factors when the local crushing feature region is the compressive crushing region, dimensionless; ΔLSS is the difference among the strength mode factors when the local crushing feature region is the shear crushing region, dimensionless; ΔLST is the difference among the strength mode factors when the local crushing feature region is the tensile crushing region, dimensionless; ΔLSCS is the difference among the strength mode factors when the local crushing feature region is the compressive-shear crushing region, dimensionless; ΔLSST is the difference among the strength mode factors when the local crushing feature region is the shear-tensile crushing region, dimensionless; ΔLSCT is the difference among the strength mode factors when the local crushing feature region is the compressive-tensile crushing region, dimensionless.
